(19) United States
(12) Patent Application Publication
(10) Pub. No.: US 2003/0108757 A1
(43) Pub. Date: Jun. 12, 2003

(54) Coated sheet-molded articles, and methods of manufacture thereof

(76) Inventors: Dennis B. Hovatter, White, MI (US); Michael T. Latocha, Lemont, IL (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/315,764

(22) Filed: Dec. 10, 2002

Related U.S. Application Data
(60) Provisional application No. 60/339,244, filed on Dec. 11, 2001.

(51) Int. Cl. B05D 3/02; B05D 1/36

(52) U.S. Cl. 428/510; 427/407.1; 427/385.5

(57) ABSTRACT

Exterior automotive quality appearance and durability of a pigmented sheet molded compound (SMC) article can be obtained by the use of at least one unpigmented coating comprising a cured thermosetting resin composition. The article can have more than one layer of unpigmented thermosetting resin coating such that the first layer is applied to form a textured appearance. The second layer can then contain an amount of flattening agent sufficient to control the overall gloss level of the resultant automotive exterior article.

### BACKGROUND

This disclosure relates to exterior coatings and, more particularly, to unpigmented exterior coatings useful for sheet-molded articles.

Sheet-molded compounds (SMC) are used in a wide variety of applications, including exterior trim articles for wheeled vehicles such as cars and trucks. Examples of SMC trim articles include spoilers, hoods, trunklids, roofs, and grilles. It is desirable that such trim articles maintain their form without becoming too soft in hot weather conditions, or too brittle in cold weather. Such products should also be capable of holding up and withstanding exposure to ultraviolet (UV) rays of the sun. It is also desirable that surface appearances of such components exhibit and maintain the desired color, gloss, and luster.

Such SMC articles are typically painted in order to provide them with a color that is compatible with the appearance of the vehicle (e.g., the same as that of the vehicle, or complimentary thereto). Following application of a pigmented coating to a molded article, usually referred to as a basecoat, a clear coat is often applied to give it luster and gloss. Spray painting of molded articles for use on vehicles has a high capital equipment cost associated with paint line equipment, and the corresponding labor involved, as well as presenting possible environmental issues relating to solvents and the like.

Use of a dry paint film, wherein a paint coat is applied to a casting sheet, and then transferred from the casting sheet to a trim panel, can be expensive, burdensome, and complicated. For example, the requirement for all of the rollers, drums, laminates, vacuum forming dies and processes, and injection-molding equipment is very expensive. The cost of tooling is also very high due to the requirement of vacuum-form tooling, injection tooling, trim tooling, drums and rollers, and the like. Moreover, the trimming of materials after placement into the vacuum-forming and injection cavities results in much waste, and lower yields. Moreover, it has been found that the life span of such trim components may be limited because they lose color quickly upon exposure to heat, sun, chemicals, and the like. Problems have also been experienced with regard to maintaining depth of image (DOI), in that DOI may be lost due to deep draws in the components. Depth of pockets or corners in the final molded components is also limited due to the dry paint film, as it may not be over-stretched or it will lose color and/or gloss.

Accordingly, there exists a need for a method for applying unpigmented coatings to pigmented sheet-molded components, and the resultant coated articles, particularly automotive exterior articles, that meet automotive manufacturers requirements.

### SUMMARY

A method for the manufacture of a coated, sheet-molded article comprises disposing a first layer of a first unpigmented thermosetting resin composition onto a sheet-molded substrate; optionally disposing a second layer of a second unpigmented thermosetting resin composition onto the first layer; and curing the first and optional second layers.

In yet another embodiment, a method for manufacturing a coated, sheet-molded article having a textured surface comprises disposing a first layer of a first, preferably low gloss, unpigmented thermosetting resin composition onto a pigmented, sheet-molded substrate to form textured surface; disposing a second layer of a second, preferably low gloss, unpigmented thermosetting resin composition onto the first layer; and curing the first and second layers.

An article, particularly an automotive exterior article, accordingly comprises a sheet-molded substrate, a first layer of a cured, unpigmented thermosetting resin coating disposed at least partially thereon, and optionally a second layer of a cured, unpigmented thermosetting resin coating disposed at least partially on the first layer.

In yet another embodiment, an article, particularly an automotive exterior article, comprises a pigmented, sheet-molded substrate, a first, textured layer of a cured, preferably low gloss, first unpigmented thermosetting resin composition disposed thereon, and a second layer of a cured, preferably low gloss, second unpigmented thermosetting resin composition disposed upon the first layer.

The above-described methods and articles are particularly useful in the formation of automotive exterior articles that meet all the physical property requirements of the automotive OEM specification. The method further allows for the formation of textured surfaces on the coated colored article, as well as varying gloss levels. More particularly, permanent color and luster can accordingly be achieved, as well as protection against scratches or other imperfections, UV degradation, environmental etching and moisture attack that further detract from the appearance of the article.

### BRIEF DESCRIPTION OF THE DRAWINGS

Referring now to the Figures wherein the like elements are numbered alike:

FIG. 1 is a cross-sectional view of one embodiment of a paint-coated sheet-molded article having a clear coat layer;

FIG. 2 is a cross-sectional view of another embodiment of a paint-coated sheet-molded article having multiple clear coat layers; and

FIG. 3 is a cross-sectional view of yet another embodiment of a paint-coated sheet-molded article having multiple clear coat layers that form a textured surface.

### DETAILED DESCRIPTION

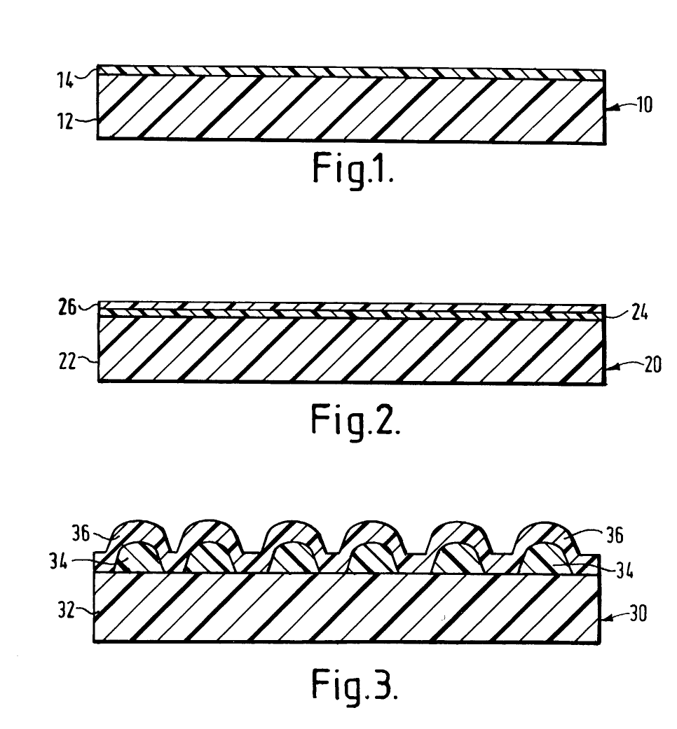

FIG. 1 illustrates an exemplary embodiment of an article 10 comprising a substrate 12 formed from a sheet-molded compound comprising a pigment or pigments, and having a first layer 14 of an unpigmented thermosetting resin composition disposed thereupon. Preferred substrates are composite materials comprising a thermosetting resin, glass fiber or inorganic reinforcing materials, filler and additives, e.g., sheet-molding compositions (SMC). Suitable commercial SMCs include but are not limited to random fiber SMC (SMC-R); directional fiber SMC (SMC-D); and continuous fiber SMC (SMC-C), mixtures comprising these three SMC materials, and combinations comprising at least one of the foregoing SMC materials, all commercially available from the Owens-Corning Fiberglass Corporation. SMC-R contains short-glass fibers (approximately 1 inch in length) oriented in a random fashion. SMC-C contains continuous glass fibers oriented in one direction, while SMC-D contains long fibers (approximately 8 to 12 inches in length), also oriented in one direction. Suitable SMCs also comprise alternative composite materials such as resin-matrix material reinforced with high-strength, high-modulus fibers of glass, carbon, aramid or boron, oriented in layers, or multi-layered fashion; and, epoxy-resin-matrix materials, phenolic-resin-matrix materials, or silicone-resin-matrix materials reinforced with oriented, continuous fibers of carbon, or combination of carbon and glass fibers fashioned in multi-layers. Suitable SMCs are commercially available from Ashland, Inc., Covington, Ky., and AOC, Collierville, Tenn.

Substrate 12 is preferably pigmented, and in the case of an exterior automotive part, is preferably pigmented so as to be compatible with the appearance of the vehicle (e.g. the same as that of the vehicle, or complimentary thereto). The pigment may be imparted to substrate 12 using ingredients and techniques known to one skilled in the art. Generally, the color pigmentation of substrate 12 is carried out to produce a desired value on a color chart. Typically, the pigmentation is provided utilizing various combinations of color pigments such as titanium dioxide, iron oxide red, iron oxide yellow, phthalocyanine green, phthalocyanine blue, blue tone phthalocyanine green, yellow tone phthalocyanine green, green tone phthalocyanine blue, lamp black, and/or carbon black, mixtures thereof, combinations comprising at least one of the foregoing pigments, and the like. The amounts of pigmentation and the particular combinations thereof utilized to achieve desired color in substrate 12 are readily determined by one of ordinary skill in the art without undue experimentation.

In addition to pigmentation, substrate 12 may also comprise other additives known in the art, such as viscosity controlling agents to aid in molding and processing, and ultraviolet radiation deterioration preventing additives. Suitable ultraviolet radiation deterioration preventing additives include carbon black, white pigments, organic ultraviolet stabilizers, hindered amine light stabilizers, anti-oxidants, and other additives, which absorb and/or reflect ultraviolet radiation.

The thermosetting resin compositions disposed as first layer 14 on substrate 12 are unpigmented. When the unpigmented thermosetting resin composition is cured, the resultant layer possesses a desired gloss level for the intended application. A variety of thermosetting resin compositions may be utilized for such applications. Suitable thermosetting resin compositions include but are not limited to unsaturated polyester resins, polyester resins containing hydroxyl functional groups, phenolic resins, epoxy resins, high-performance epoxy resins, bismaleimides, modified bismaleimides (e.g., epoxy modifications, biscyanate modifications, rubber-toughened bismaleimides, thermoplastic-toughened bismaleimides, and the like), acrylic resins, acrylic resins containing hydroxyl and/or carboxyl functional groups, fluorocarbon resins (e.g., 2-part fluorocarbon modified urethane resin), silicon modified resins (e.g., silicon modified acrylic clear, 2-part silicon modified urethane, and the like), amino resins (e.g., aminoalkyl resin, and the like) melamine resins, isocyanate resins, blocked isocyanate resins, mixtures comprising at least one of the foregoing thermosetting resins, and combinations comprising at least one of the foregoing thermosetting resins, and the like. Preferably, the thermosetting resin composition comprises a combination of an acrylic-polyester resin blend containing hydroxyl functional groups, and an isocyanate compound, which when cured forms a polyurethane coating. Such a preferred thermosetting resin composition is commercially available under the trade name “R798WT”, from Rohm and Haas Automotive Coatings in Lansing, Ill. Thermosetting resin compositions that appear transparent, or substantially transparent, when cured, baked, and the like, may be employed depending upon the particular application and intended use.

In one method of manufacture, layer 14 of an unpigmented thermosetting resin composition can be disposed as a liquid phase in thin film form onto the surface of substrate 12, e.g., a solvent containing the resin composition. The thermosetting resin composition may be applied using any conventional method known to one skilled in the art. “Thin film form” generally refers to a layer having a thickness of 0.25 to 2.50 mils (6.35 to 63.5 micrometers), preferably 0.5 to 2.25 mils (12.7 to 57.15 micrometers), more preferably 1.00 to 2.00 mils (25.4 to 50.8 micrometers), and most preferably 1.3 to 1.7 mils (33.02 to 43.18 micrometers). The unpigmented thermosetting resin composition may include a flattening agent, and a cross-linking agent for curing and/or baking purposes. Generally, flattening agents are employed to change the gloss and shine of a coating to a desired gloss level. An amount of flattening agent sufficient to achieve the desired low gloss level of article 10 can be readily ascertained by one of ordinary skill in the art without undue experimentation. More particularly, the thermosetting resin composition may comprise 1 to 30 weight percent (wt. %) based on the total weight of the thermosetting resin composition of a flattening agent, preferably 5 to 20 wt. %, and most preferably 7 wt. % to 13 wt. %. Suitable flattening agents include but are not limited to porous materials having a pore volume of 0.4 to 4.0 milligrams and a particle size of 3 to 15 microns, e.g., thermally derived silicas, precipitated silicas, surface treated above mentioned silicas; various inorganic salts such as magnesium silicate and barium sulfate; and various crosslinked organic compounds; and the like. Suitable curing agents include but are not limited to blocked polyisocyanates, polyisocyanates, alkylated melamines, and the like.

The thermosetting resin composition is heated at a temperature sufficient to cure the composition, e.g., by applying heat in successive stages until solvent contained in the thermosetting resin composition is driven off, while maintaining a temperature below the softening point of the substrate material so as not to deform the substrate. Such cure temperatures are readily ascertainable to one of ordinary skill in the art when considering factors such as the type of substrate material and thermosetting resin composition being employed. More particularly, the curing temperature comprises a high cure temperature of 160 degrees Centigrade (° C.), preferably 140° C., most preferably 120° C., and a lower cure temperature of 40° C., preferably 60° C., most preferably 110° C., or a range of 40° C. to 160° C.

FIG. 2 illustrates an exemplary embodiment of another article particularly suitable for use as an automotive exterior article. Article 20 comprises a substrate 22 coated with a first layer 24 of a first unpigmented, preferably low gloss thermosetting resin composition disposed thereupon, and a second layer 26 of a second unpigmented, preferably low gloss thermosetting resin composition disposed on the first layer. The substrate 22 is as described above, and first and second layers 24, 26 on substrate 22 both comprise the unpigmented thermosetting resin composition that preferably includes a flattening agent and, optionally, a cross-linking agent, as described above. In an alternative embodiment, the flattening agent concentration of the first and second layers 24, 26 may be varied to alter the resultant gloss level and finish of the coated article. For example, the first layer 24 may contain no flattening agent so that a film of high gloss level is formed. The second layer 26 may then contain an amount of flattening agent sufficient to form a low gloss level, which when applied to the first layer 24, will control the ultimate gloss level and finish of the coated article.

In a method for manufacturing article 20, a first layer 24 of the unpigmented thermosetting resin composition can be disposed as a liquid phase in thin film form as described above onto the surface of substrate 22, e.g., a solvent containing the thermosetting resin composition. A second layer 26 of the same, or a different, unpigmented thermosetting resin composition can be disposed in a liquid phase in thin film form onto the surface of substrate 22. More particularly, a wet-on-wet method, as is known to one skilled in the art, is preferably employed to apply second layer 26 onto first layer 24. Substrate 22 comprising both first layer 24 and second layer 26 is heated at a temperature sufficient to cure the thermosetting resin composition, yet below the softening point of the substrate material so as not to deform the substrate. Such cure temperatures are readily ascertainable to one of ordinary skill in the art depending upon the type of substrate material, thermosetting resin composition being employed, the desired gloss level, and the like. More particularly, the curing temperature comprises a high cure temperature of 160 degrees Centigrade (° C.), preferably 140° C., most preferably 120° C., and a lower cure temperature of 40° C., preferably 60° C., most preferably 110° C., or a range of 40° C. to 160° C.

Referring now to FIG. 3, in another method for manufacturing a coated, sheet-molded article, an article 30 comprises a substrate 32 having a first layer 34 of an unpigmented thermosetting resin composition, and a second layer 36 of the same, or a different unpigmented thermosetting resin composition, wherein the first layer 34 forms a textured appearance on the exterior surface of substrate 32 and the second layer provides a continuous film to protect the substrate and textured layer. As described above, first and second layers 34, 36 both comprise the unpigmented thermosetting resin composition that preferably includes a flattening agent and, optionally, a cross-linking agent. The gloss level and finish of the coated article may be varied by controlling the amount of flattening agent to the thermosetting resin compositions of either or both first and second layers 34, 36. Preferably, the gloss level of both layers 34, 36 are low.

The thermosetting resin composition of layer 34 is applied to form a textured surface, for example, as a liquid phase onto substrate 32 using a spatter technique known to one of ordinary skill in the art. For example, the thermosetting resin composition can be spattered onto the exterior surface of substrate 32 to form a textured appearance such as a pattern, design, and the like. The pattern or design can be aesthetic, or possess utility, to cover up molding defects and the like. Preferably, an amount of thermosetting resin composition sufficient to form a raised pattern on the surface of substrate 32 is applied.

Second layer 36 of unpigmented thermosetting resin composition can be disposed as a liquid phase in thin film form onto the textured surface of substrate 32. Preferably, a wet-on-wet method, as is known to one skilled in the art, is preferably employed to apply second layer 36 onto first layer 34, such that second layer 36 preferably conforms and distributes evenly over the textured surface of substrate 32. Substrate 32 comprising both first layer 34 and second layer 36 is heated at a temperature sufficient to cure the thermosetting resin composition, yet below the softening point of the substrate material so as not to deform the substrate as described above.

Generally, the second layer provides the above-described durability and appearance properties, including gloss, which enables the thermosetting resin composition to function as an exterior automotive coating. The thermosetting resin compositions are selected for use in this inventive method by a combination of exterior automotive durability properties and gloss and other appearance properties of the finished paint coat. The specifications for a paint coat for exterior automotive use include but are not limited to the mechanical properties of hardness; abrasion resistance; thermal stability, including heat resistance; resistance to gasoline and acids; cleanability; adhesion; certain weatherability properties such as UV resistance and resistance to water and humidity exposure; and impact strength. For simplicity, these properties are referred to collectively herein as “durability properties.”

Weatherability, which is measured, in part, by UV resistance properties, is a durability property commonly used in the art to define standards for an exterior automotive paint coat. To measure UV resistance can require long-term exposure testing of the paint coat, for up to a period of ten years. Accelerated UV resistance and weatherability tests of the paint coat have been completed and are described below. In addition to durability properties, the specifications for an exterior automotive quality paint coat also include tests to measure the visual appearance qualities of the finished surface. These criteria include gloss, color, distinctiveness-of-image (DOI), dry film thickness, and spatter height, width, and density.

The inventive method and resultant articles possess advantages such as a reduction in materials and equipment costs. For example, by using pigmented substrates, pigmented paints are not needed. In addition, the gloss level of the coated article is controlled using a combination of unpigmented thermosetting resin compositions at various gloss levels layered upon the article. Furthermore, the article may be textured using the thermosetting resin composition to provide a commercially attractive exterior, e.g. by spattering the composition upon a substrate's exterior surface to impart a raised, textured design or pattern. Such designs or patterns can be aesthetic or possess utility such as covering up molding defects and the like. Since another unpigmented thermosetting resin composition coating is then applied which totally coats the substrate and optional spattered layer, there is no concern that the resultant article may lose its desired color and/or gloss level upon exterior exposure.

The coated articles may be employed as exterior articles. Generally, such exterior articles are adapted to be mounted on all types of automotive vehicles including but not limited to automobiles, trucks, and SUV's. These exterior articles may be manufactured so that the exterior appearance either matches the color of the corresponding vehicle, or complements the color of the corresponding vehicle. Exemplary automotive exterior articles comprise wheel covers, door sides, bumper fascia, trunk lids, claddings, body side moldings, roof moldings, beltline moldings, window moldings, grills, and the like. In other embodiments, entire exterior automobile body panels such as hoods, door panels, quarter panels, trunks, and the like may be made in accordance with the present inventive method and resultant articles. In certain other embodiments, the resultant exterior articles may be utilized as components for other mobile devices including but not limited to snowmobiles, lawn tractors, and the like. For example, the inventive methods and resultant articles may be used as hoods or other types of panels on such mobile vehicles.

The following examples further describe the inventive method and resultant articles. The table illustrates the results of subjecting coated SMC articles to industry test methods for exterior automotive articles, wherein the articles comprise a low gloss clear R798WT topcoat system. This system is a two coat system, wherein the first coating is a low gloss unpigmented spatter coating, onto which a low gloss unpigmented smooth coating is applied wet on wet. The coated articles were baked at various temperatures from 80° C. to 120° C.

| Test Method | Lab Procedure | Test Duration | Result |
|---|---|---|---|
| Atmospheric | LP-463PB-6-01 | HCl | PASS |
| Etch | | H₂SO₄ | PASS |
| Resistance | | HNO₃ | PASS |
| | | H₂O | PASS |
| | | Acid Rain Solution at | |
| | | pH 2 | PASS |
| | | pH 4 | PASS |
| | | Bee Pollen | PASS |
| Initial Adhesion | LP-463PB-15-01 | Method B | PASS |
| Solvent Wipe | LP-463PB-7-01 | MS-1316 | PASS |
| Resistance | | | |
| Cycle Crack | LP-463PB-22-01 | 15 cycles, check adhesion | PASS |
| Resistance | | using 463PB-15-01, | |
| (Method IV) | | Method B | |
| Gravelometer | SAE J400 | 5 pints at 45 degree angle | PASS |
| Resistance | | | |
| Humidity | ASTM D1735 | 240 hours, check adhesion | PASS |
| Resistance | | using 463PB-15-01 | |
| Impact | LP-463PB-19-01 | 80 inch/lb | PASS |
| Resistance | | | |
| Xenon Arc | SAE J1960 | 2500 kj, check adhesion | PASS |
| Weatherometer ® | | using 463PB-15-01 | |
| Exposure | | 4000 kj, check adhesion and | PASS 100% |
| | | color retention | Adhesion, Color |
| | | | Change > 1.5 DE |

With regard to atmospheric etch, the coated articles withstood exposure to hydrochloric acid, sulfuric acid, nitric acid, water, acid rain solution at pH2; pH4, and bee pollen without any evidence of defects such as etching, staining, whitening or darkening. Details of this test procedure are described in Daimler-Chrysler test specification LP-463PB-6-01.

With regard to initial adhesion, all of the R798WT low gloss clear coatings adhered to their respective articles. Details of this test procedure are described in Daimler-Chrysler test specification LP-463PB-15-01, Method B.

With regard to solvent wipe, all of the R798WT low gloss clear coatings of each coated article demonstrated no substantial evidence of staining, discoloring or softening of their respective substrate's exterior surface. Details of this test procedure are described in Daimler-Chrysler test specification LP-463PB-7-01, MS-1316.

As for cycle crack (method IV), each of the aforementioned R798WT low gloss clear coatings adhered to their respective articles in accordance with Daimler-Chrysler test specification LP-463PB-15-01, Method B, after undergoing fifteen cycles as defined in Daimler-Chrysler test specification LP-463PB-22-01.

As for chip resistance, the coated article comprising the R798WT coated SMC substrate withstood the Gravelometer standard test identified in SAE J-400.

With regard to humidity exposure, each coated article can withstand two hundred forty hours of humidity exposure as defined in ASTM D1735 without any evidence of blistering. In addition, each coating adhered to its respective article in accordance with Daimler-Chrysler test specification LP-463PB-15-01, Method B.

With regard to impact resistance, each coated article can withstand at least 80 pounds per square inch of direct impact with no failure in accordance with Daimler-Chrysler test specification LP-463PB-19-01.

With regard to weathering using Xenon Arc Weatherometer® exposure, the coated articles did not show any signs of significant deterioration or embrittlement, loss of adhesion, objectionable shrinkage, or noticeable color or gloss change after a duration of 2500 kilojoules in accordance with SAE J-1960 test method, while the coated article comprising the R798WT coated SMC substrate exhibited only a slight color change of less than 1.5 Delta E, and no signs of significant deterioration or embrittlement, loss of adhesion, or objectionable shrinkage at an output of 4000 kilojoules in accordance with SAE J-1960 test method. In addition, each coating adhered to its respective article in accordance with Daimler-Chrysler test specification LP-463PB-15-01, Method B.

What is claimed is:

1. A method for manufacturing a, sheet-molded article, comprising:
disposing a first layer of a first unpigmented thermosetting resin composition onto a sheet-molded substrate;
optionally disposing a second layer of a second unpigmented thermosetting resin composition onto the first layer; and
curing the first and optional second layers.

2. The method of claim 1, wherein the first composition forms a low gloss layer after cure and the second composition forms a low gloss layer after cure.

3. The method of claim 1, wherein the first layer forms a textured surface on the substrate.

4. The method of claim 1, wherein the first and optional second layers are cured simultaneously.

5. A method for manufacturing a pigmented, sheet-molded article having a textured surface, comprising:
spattering a first layer of a first, low gloss, unpigmented thermosetting resin composition onto a pigmented, sheet-molded substrate to form a textured surface;
disposing a second layer of a second, low gloss unpigmented thermosetting resin composition onto the first, uncured layer; and
curing the first and second layers.

6. An article, comprising:
a sheet-molded substrate;
a first layer of a cured, unpigmented thermosetting resin coating disposed at least partially thereon; and
optionally a second layer of a cured, unpigmented thermosetting resin coating disposed at least partially on the first layer.

7. An article for an automotive exterior, comprising
a pigmented, sheet-molded substrate;
a first, textured layer of a cured, low gloss, first unpigmented thermosetting resin composition disposed thereon; and
a second layer of a cured, low gloss, second unpigmented thermosetting resin composition disposed upon the first textured layer.

8. The article of claim 6 or 7, wherein the first and second unpigmented thermosetting resin composition is an unsaturated polyester resin, polyester resin containing hydroxyl functional groups, phenolic resin, epoxy resin, high performance epoxy resin, bismaleimide, rubber-toughened bismaleimide, thermoplastic-toughened bismaleimide, acrylic resin, acrylic resin containing hydroxyl and/or carboxyl functional groups, fluorocarbon resin, silicon modified resin, amino resin, melamine resin, isocyanate resin, blocked isocyanate resin, or a combination comprising at least one of the foregoing thermosetting resin compositions.

9. The article of claim 6 or 7, wherein the first and second unpigmented thermosetting resin compositions comprises a combination of acrylic hydroxyl functional and hydroxyl functional polyester resins and an isocyanate compound, a curing agent and a flattening agent.

10. The article of claim 6 or 7, wherein the article has an impact resistance of at least 80 pounds per square inch pursuant to Daimler-Chrysler test specification LP-463PB-19-01.

11. The article of claim 6 or 7, wherein each of the first and second layers is 6.35 to 63.5 micrometers thick.

12. The article of claim 6 or 7, wherein the article is one of a wheel cover, door side, bumper fascia, trunk lid, cladding, body side molding, roof, roof molding, beltline molding, window molding, grill, hood, door panel, quarter panel, or trunk.
